(19) United States
(12) Patent Application Publication
(10) Pub. No.: US 2016/0341299 A1
(43) Pub. Date: Nov. 24, 2016

(54) GEAR BOX COOLING SYSTEM FOR A ROCK HEADER

(71) Applicant: Caterpillar Inc., Peoria, IL (US)

(72) Inventors: Raymond Gerges, New Lenox, IL (US); Trevor William Somers, Shorewood, IL (US); Dirk Voß, Menden (DE)

(73) Assignee: Caterpillar Inc., Peoria, IL (US)

(21) Appl. No.: 15/229,647

(22) Filed: Aug. 5, 2016

(51) Int. Cl. F16H 57/04

(52) U.S. Cl. CPC F16H 57/0412; F16H 57/0436; F16H 57/0435

(57) ABSTRACT

A transmission system for a rock header includes a gearbox having a first outlet line and a second outlet line disposed parallel to the first outlet line. Each of the first and second outlet lines may allow egress of oil from the gearbox. A first gear pump and a second gear pump are disposed in fluid communication with the first outlet line and the second outlet line respectively for operatively scavenging oil from the gearbox. A first intermediary fluid line communicates oil from an outlet of the first gear pump to an inlet of the second gear pump, and a second intermediary fluid line communicates oil from an outlet of the second gear pump to an inlet of the first gear pump. The system also includes a first orifice placed in the first intermediary line, and a second orifice placed in the second intermediary line.

### TECHNICAL FIELD

The present disclosure relates to a gear box cooling system for a rock header mining application. More particularly, the present disclosure relates to a hydraulic cooling and anti-aeration system provided in association with a gearbox used in the rock header mining application.

### BACKGROUND

Rock headers are used to harvest mineral deposits, for example, hard rock seams present in the earth. These rock headers are typically provided with a gearbox which enables rotation of a cutting tool mounted on the free end of the boom for performing a rock cutting operation.

As the rotary cutting tool may be subject to extreme operating conditions, the gearbox may also experience increased heat during operation. Therefore, cooling circuits with one or more scavenging fluid pumps may be provided to the gearbox for circulating oil into and out of the gearbox. However, with variations of gearbox rotation during operation, pump suction lines may become fully or partially exposed to air thereby leading to oil aeration. As known to persons skilled in pump design and validation, over a prolonged period of time and use, aeration could lead to deterioration in the performance of the fluid pumps and may eventually cause pump failure.

Hence, there is a need for a system that minimizes a possibility of aeration from occurring in scavenging fluid pumps of Rock Headers.

### SUMMARY OF THE DISCLOSURE

In an aspect of the present disclosure, a transmission system for a rock header includes a gearbox. The gearbox is provided with an inlet line, a first outlet line, and a second outlet line disposed in parallel relation to the first outlet line. The inlet line is configured to supply oil to the gearbox while each of the first and second outlet lines is configured to allow egress of oil from the gearbox.

Further, the transmission system also includes a cooling system disposed in fluid communication with the gearbox via the first and second outlet lines. The cooling system includes a first gear pump disposed in fluid communication with the first outlet line and a second gear pump that is disposed in fluid communication with the second outlet line. Each of the first and second gear pumps is configured to operatively scavenge oil from the gearbox via the first outlet line and the second outlet line respectively.

Furthermore, the transmission system also includes an anti-aeration system having a pair of intermediary fluid lines. A first intermediary fluid line of the anti-aeration system is configured to fluidly communicate oil from an outlet of the first gear pump to an inlet of the second gear pump while a second intermediary fluid line of the anti-aeration system is configured to fluidly communicate oil from an outlet of the second gear pump to an inlet of the first gear pump. The anti-aeration system also includes a first orifice that is disposed in the first intermediary line, and a second orifice that is disposed in the second intermediary line.

Other features and aspects of this disclosure will be apparent from the following description and the accompanying drawings.

### BRIEF DESCRIPTION OF THE DRAWINGS

FIG. 1 is a perspective view of an exemplary rock header, in which embodiments of the present disclosure may be implemented; and

FIG. 2 is a schematic of a transmission system for the exemplary rock reader, in accordance with an embodiment of the present disclosure.

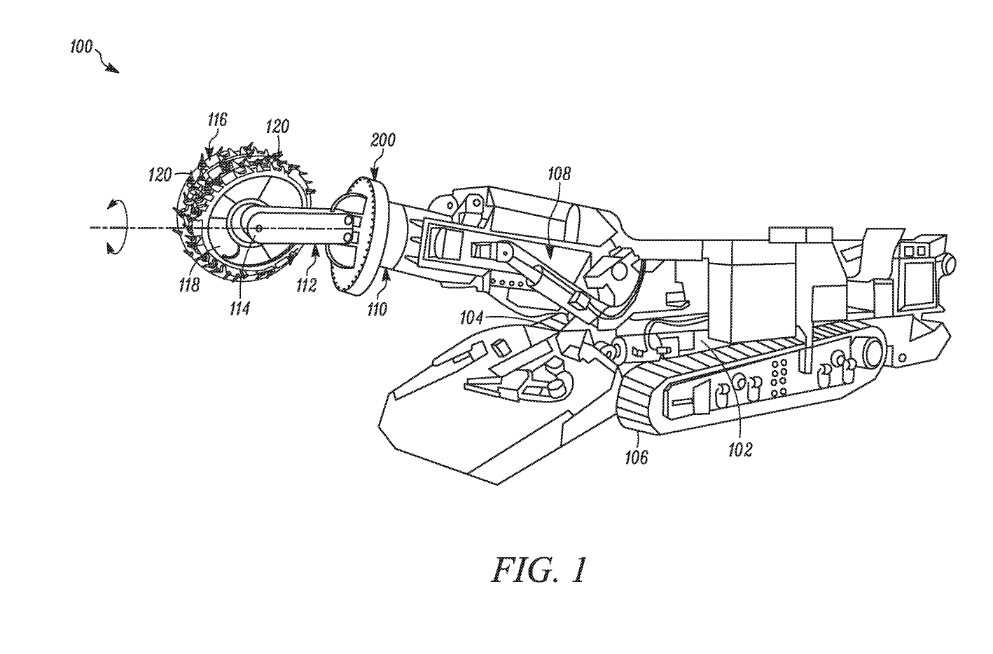

### DETAILED DESCRIPTION

Wherever possible, the same reference numbers will be used throughout the drawings to refer to the same or the like parts. Referring to FIG. 1, an exemplary rock header 100 is illustrated. As shown, the rock header 100 includes a frame 102. The frame 102 may be movably supported on a pair of ground engaging members 104, 106 which are embodied exemplarily in the form of crawlers as shown in the illustrated embodiment of FIG. 1.

The rock header 100 also includes a boom 108 that is pivotally coupled to the frame 102. The boom 108 has a first portion 110 and a second portion 112 that is rotatably coupled to the first portion 110. The second portion 112 is configured to co-axially rotate in relation to the first portion 110.

Moreover, a free end 114 of the second portion 112 is adapted to support a rotary cutting tool 116 thereon. As shown in the illustrated embodiment of FIG. 1, the rotary cutting tool 116 may be implemented by a rotary head 118 bearing a series of cutters 120 thereon. It may be noted that a configuration of the rotary cutting tool 116 disclosed in the illustrated embodiment of FIG. 1 is merely exemplary in nature and hence, non-limiting of this disclosure. Persons skilled in the art will acknowledge that the configuration of the rotary cutting tool 116 used on the rock header 100 may vary from one application to another depending on specific requirements of an application.

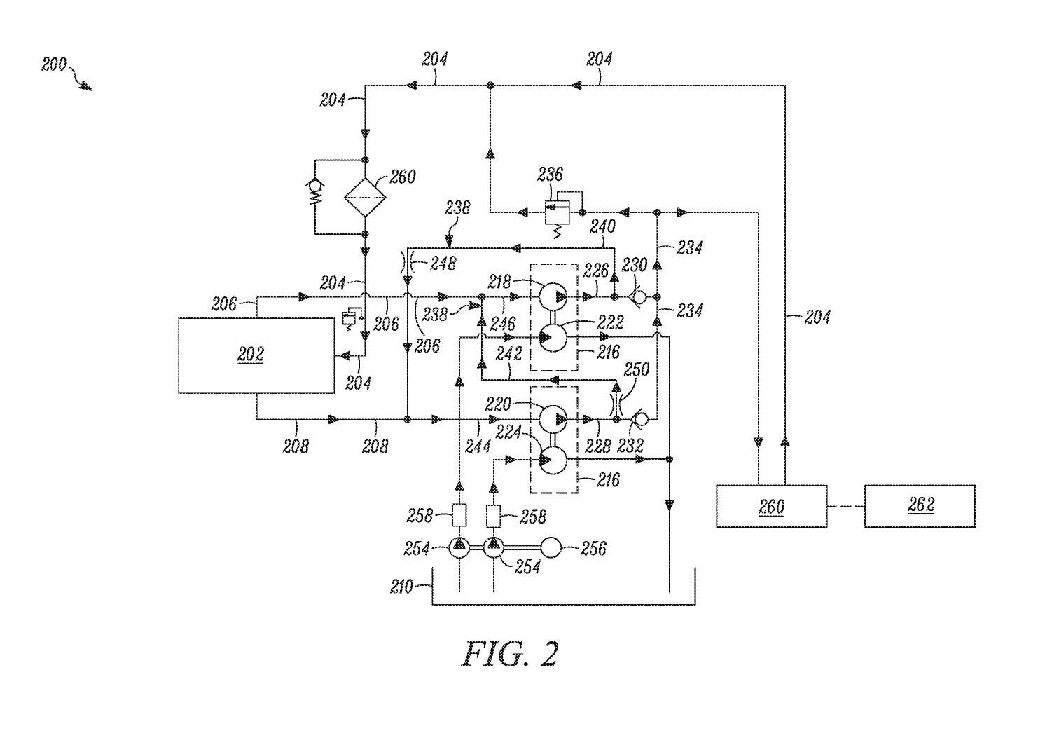

The present disclosure relates to a transmission system 200 that is configured to operatively rotate the second portion 112 of the boom 108 relative to the first portion 110 of the boom 108. As shown in the schematic illustration of FIG. 2, the transmission system 200 includes a gearbox 202 that is provided with an inlet line 204, a first outlet line 206, and a second outlet line 208 disposed in parallel relation to the first outlet line 206. The inlet line 204 is configured to supply oil to the gearbox 202, for example, from a reservoir 210 via a main hydraulic pump 254 via a pair of corresponding electronically controlled hydraulic valves 258, the main hydraulic pump 254 being driven by a prime mover 256 e.g., an electric motor as shown in FIG. 2.

In addition to the reservoir 210, in an embodiment, the inlet line 204 and the pair of outlet lines 206, 208 may be configured e.g., recombined such that they form a closed loop circuit at least at one point partway between the reservoir 210 and the gearbox 202 to interface with a heat exchanger 260 operatively controlled by a controller 262 as shown in the illustrated embodiment of FIG. 2.

Moreover, although an electric motor is disclosed herein, other types of prime movers including, but not limited to, internal combustion engines may be used in lieu of the electric motor disclosed herein. Each of the first and second outlet lines 206, 208 is configured to allow egress of oil from the gearbox 202, for example, back to the reservoir 210 or the heat exchanger 260, as the case may be.

The transmission system 200 further includes a cooling system 216 disposed in fluid communication with the gearbox 202 via the first and second outlet lines 206, 208. The cooling system 216 includes a pair of gear pumps i.e., a first gear pump 218 and a second gear pump 220. The first gear pump 218 is disposed in fluid communication with the first outlet line 206 and the second gear pump 220 is disposed in fluid communication with the second outlet line 208. Each of the first and second gear pumps 218, 220 is configured to operatively scavenge oil from the gearbox 202.

As shown in the illustrated embodiment of FIG. 2, the cooling system 216 further includes a pair of hydraulic gear motors a first hydraulic gear motor 222 and a second hydraulic gear motor 224. The first hydraulic gear motor 222 is configured to operatively drive the first gear pump 218 and the second hydraulic motor 224 is configured to operatively drive the second gear pump 220. The pair of hydraulic gear motors 222, 224 may be driven using fluid pressurized from one or more driver hydraulic pumps 254 driven by power from a secondary prime mover 256.

In embodiments of this disclosure, it may be noted that the first and second gear pumps 218, 220 are fixed displacement pumps and the first and second hydraulic motors 222, 224 are fixed displacement motors. However, in other embodiments, persons skilled in the art may contemplate incorporating variable displacement pumps and motors in lieu of respective ones or all of the fixed displacement pumps and motors disclosed herein depending on specific requirements of an application.

Moreover, an outlet 226 of the first gear pump 218 and an outlet 228 of the second gear pump 220 are disposed in fluid communication with a first check valve 230 and a second check valve 232 respectively. As shown in the illustrated embodiment of FIG. 2, the cooling system 216 further includes a main output line 234 located downstream of the first and second check valves 230, 232 and disposed in selective fluid communication with each of the first and second outlet lines 206, 208. The first and second check valves 230, 232 are configured to allow a unidirectional flow of oil from respective ones of the first and second outlet lines 206, 208 to the main output line 234.

Furthermore, the cooling system 216 also includes a pilot controlled relief valve 236 that is configured to selectively communicate oil from the main output line 234 to the inlet line 204 associated with the gearbox 202. The relief valve 236 may be of a type that works on a spring-operated pilot relief setting. The relief valve 236 may be set to open at a pre-determined pressure value depending on specific requirements of an application.

The transmission system 200 further includes an anti-aeration system 238 having a pair of intermediary fluid lines i.e., a first intermediary fluid line 240 and a second intermediary fluid line 242. The first intermediary fluid line 240 is configured to fluidly communicate oil from the outlet 226 of the first gear pump 218 to an inlet 244 of the second gear pump 220. The second intermediary fluid line 242 is configured to fluidly communicate oil from the outlet 228 of the second gear pump 220 to an inlet 246 of the first gear pump 218. As shown in the illustrated embodiment of FIG. 2, the anti-aeration system 238 also includes a first orifice 248 that is disposed in the first intermediary fluid line 240, and a second orifice 250 that is disposed in the second intermediary fluid line 242. The first and second orifices 248, 250 are configured to regulate a mass flow rate of the oil being pumped into the first and second intermediary fluid lines 240, 242 by respective ones of the first and second gear pumps 218, 220.

During operation, the gearbox 202 receives oil from the source through the inlet line 204 via a filtration device 260. This oil may heat up within the gearbox 202 depending on various operating conditions of the gearbox 202. The heated oil from the gearbox 202 may be scavenged by one or both gear pumps i.e., the first and/or second gear pumps 218, 220 depending on various factors including, but not limited to, an angle of the cutting tool 116 with respect to the frame 102 of the rock header 100, a rotation angle of the second portion 112 of the boom 108 with respect to the first portion 110 of the boom 108, a speed of rotation of the second portion 112 in relation to the first portion 110 of the boom 108, and the like.

While scavenging, if one of the gear pumps i.e., the first gear pump 218 or the second gear pump 220 begins to receive little or no oil from the gearbox 202, oil from the other gear pump i.e., the first gear pump 218 or the second gear pump 220 enters the first or the second intermediary fluid line 242 to the gear pump i.e., the first gear pump 218 or the second gear pump 220 that begins to receive little or no oil from the gearbox 202.

For example, if the first gear pump 218 begins to receive little or no oil from the gearbox 202, oil from the outlet 228 of the second gear pump 220 may be routed through the second intermediary fluid line 242 to the inlet 246 of the first gear pump 218. Likewise, in another example, if the second gear pump 220 begins to receive little or no oil from the gearbox 202, oil from the outlet 226 of the first gear pump 218 may be routed through the first intermediary fluid line 240 to the inlet 244 of the second gear pump 220. Thus, a possibility of air entering the first or second gear pumps 218/220 may be reduced to minimize or prevent aeration from occurring in the first or second gear pumps 218/220.

Various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, suth joinder references do not necessarily infer that two elements are directly connected to each other.

Additionally, all numerical terms, such as, but not limited to, “first”, “second”, “third”, “primary”, “secondary” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure has applicability for use and implementation in minimizing the possibility of aeration from occurring at scavenging pumps present in one or more cooling circuits of a gearbox 202. As known to persons skilled in the art, gears pumps are typically prone to deterioration in performance with the occurrence of aeration within the gear pumps.

With use of embodiments disclosed herein, manufacturers can build transmission systems that allow efficient cooling of an associated gearbox while minimizing aeration issues typically experienced by scavenging pumps of conventional cooling circuits present in previously known transmission systems. With implementation of the first and second intermediary fluid lines 240, 242 in the transmission system 200 disclosed herein, oil is routed to either of the first or second gear pumps 218, 220 to prevent air from entering the first and second gear pumps 218, 220 thereby minimizing or preventing aeration from occurring in the first and second gear pumps 218, 220. Therefore, a service life of the scavenging first and second gear pumps 218, 220 may be prolonged leading to reduced maintenance costs with use of the transmission system 200. This way, manufacturers may beneficially entail reduced costs, time, and effort required in the servicing or replacement of scavenging pumps associated with transmission systems.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A transmission system for a rock header, the gear box cooling system comprising:
a gearbox comprising an inlet line, a first outlet line, and a second outlet line disposed in parallel relation to the first outlet line, wherein the inlet line is configured to supply oil to the gearbox while each of the first and second outlet lines is configured to allow egress of oil from the gearbox;
a cooling system disposed in fluid communication with the gearbox via the first and second outlet lines, the cooling system comprising a pair of gear pumps wherein a first gear pump is disposed in fluid communication with the first outlet line and a second gear pump is disposed in fluid communication with the second outlet line, each of the first and second gear pumps being configured to operatively scavenge oil from the gearbox;
an anti-aeration system comprising:
a pair of intermediary fluid lines wherein a first intermediary fluid line is configured to fluidly communicate oil from an outlet of the first gear pump to an inlet of the second gear pump, and wherein a second intermediary fluid line is configured to fluidly communicate oil from an outlet of the second gear pump to an inlet of the first gear pump; and
a first orifice being disposed in the first intermediary line, and a second orifice being disposed in the second intermediary line.

2. The transmission system of claim 1, wherein an outlet of the first gear pump and an outlet of the second gear pump are disposed in fluid communication with a first check valve and a second check valve respectively.

3. The transmission system of claim 1, wherein the cooling system further comprising a main output line located downstream of the first and second check valves and disposed in selective fluid communication with each of the first and second outlet lines, wherein the first and second check valves are configured to allow a unidirectional flow of oil from respective ones of the first and second outlet lines to the main output line.

4. The transmission system of claim 1, wherein the cooling system further comprises a pilot controlled relief valve configured to selectively communicate oil from the main output line to the inlet line associated with the gearbox.

5. The gear box cooling system of claim 1, wherein the cooling system further comprises a pair of hydraulic motors wherein a first hydraulic motor is configured to operatively drive the first gear pump and a second hydraulic motor is configured to operatively drive the second gear pump.
